(19) United States
(12) Patent Application Publication
(10) Pub. No.: US 2025/0327409 A1
(43) Pub. Date: Oct. 23, 2025

(54) GEOMETRICALLY SEGMENTED COATING FOR THERMAL INSULATION AND ABRADABILITY PROTECTION

(71) Applicant: RTX Corporation, Farmington, CT (US)

(72) Inventors: Juan Gomez, El Paso, TX (US); Samuel J. Jacobs, Broad Brook, CT (US); Daniel Gabriel Valente, Manchester, CT (US)

(73) Assignee: RTX Corporation, Farmington, CT (US)

(21) Appl. No.: 18/639,083

(22) Filed: Apr. 18, 2024

(51) Int. Cl. F01D 5/28

(52) U.S. Cl. CPC F01D 5/288; F05D 2250/21; F05D 2300/611

(57) ABSTRACT

A process of preventing spallation for a geometrically segmented thermally insulating top coat on an article, the process including forming a surface feature with a surface feature tip on a surface of the article; disposing the thermally insulating topcoat over the surface feature; and forming segmented portions that are separated by faults extending through the thermally insulating topcoat from the surface feature tip.

### BACKGROUND

The present disclosure is directed to the improved geometrically modified thermal insulation coating. Particularly, a coating system which incorporates features formed into the bond coat enhances the formation of vertical cracks in the thermal insulation coating to increase strain tolerance at very high coating thickness.

Components that are exposed to high temperatures, such as a component within a gas turbine engine, typically include protective coatings. For example, components such as turbine blades, turbine vanes, blade outer air seals, combustor and compressor components typically include one or more coating layers that function to protect the component from erosion, oxidation, corrosion or the like to thereby enhance component durability and maintain efficient operation of the engine.

Increasing emphasis on environmental issues and fuel economy continue to drive turbine temperatures up. The higher engine operating temperatures results in an ever-increasing severity of the operating environment inside a gas turbine. The severe operating environment results in more coating and base metal distress and increased maintenance costs.

A coating exists called a geometrically segmented abradable ceramic, (GSAC). The GSAC in development has the potential to satisfy the above described needs in many applications, however the most severe service environments still cause the ceramic surface layer of GSAC to spall.

### SUMMARY

In accordance with the present disclosure, there is provided a process of preventing spallation for a geometrically segmented thermally insulating top coat on an article, the process comprising: forming a surface feature with a surface feature tip on a surface of the article; disposing the thermally insulating topcoat over the surface feature; and forming segmented portions that are separated by faults extending through the thermally insulating topcoat from the surface feature tip.

A further embodiment of any of the foregoing embodiments may additionally and/or alternatively include the surface feature comprising a pyramid shape.

A further embodiment of any of the foregoing embodiments may additionally and/or alternatively include the surface comprises a surface of a substrate of the article.

A further embodiment of any of the foregoing embodiments may additionally and/or alternatively include the surface comprising a surface of a bond coat disposed on a substrate of the article.

A further embodiment of any of the foregoing embodiments may additionally and/or alternatively include the surface feature comprising a pyramid shape including a surface feature base width and a surface feature tip width, wherein a ratio of the surface feature base width to the surface feature tip width comprising from 0.0 to 0.22.

A further embodiment of any of the foregoing embodiments may additionally and/or alternatively include the article is a gas turbine engine component.

A further embodiment of any of the foregoing embodiments may additionally and/or alternatively include the gas turbine engine component is at least one of an airfoil, a platform, a seal, a bulkhead, a fuel nozzle guide, a transition duct and a combustor liner.

In accordance with the present disclosure, there is provided a geometrically segmented thermally insulating top coat on an article comprising: a surface feature shaped as a pyramid with a surface feature tip, the surface feature formed on a surface of the article; the thermally insulating topcoat being disposed over the surface feature; and segmented portions that are separated by faults extending through the thermally insulating topcoat from the surface feature tip.

A further embodiment of any of the foregoing embodiments may additionally and/or alternatively include the surface comprising a surface of a substrate of the article.

A further embodiment of any of the foregoing embodiments may additionally and/or alternatively include the surface comprising a surface of a bond coat disposed on a substrate of the article.

A further embodiment of any of the foregoing embodiments may additionally and/or alternatively include the surface feature comprising a surface feature base width and a surface feature tip width, wherein a ratio of the surface feature base width to the surface feature tip width comprises from 0.0 to 0.22.

A further embodiment of any of the foregoing embodiments may additionally and/or alternatively include the pyramid shaped geometric surface feature comprising an elongated side having the elongated side of a surface feature base width longer than another surface feature base width.

A further embodiment of any of the foregoing embodiments may additionally and/or alternatively include the resulting shape of the surface feature comprising an elongated rib shape.

In accordance with the present disclosure, there is provided a process of interrupting spallation for geometrically segmented coatings on a gas turbine engine component comprising: the gas turbine engine component having a surface; forming a surface feature with a surface feature tip on the surface of the gas turbine engine component; disposing the thermally insulating topcoat over the surface feature; and forming segmented portions that are separated by faults extending through the thermally insulating topcoat from the surface feature tip.

A further embodiment of any of the foregoing embodiments may additionally and/or alternatively include the surface feature comprising a pyramid shape.

A further embodiment of any of the foregoing embodiments may additionally and/or alternatively include the surface comprising a surface of a substrate of the gas turbine engine component.

A further embodiment of any of the foregoing embodiments may additionally and/or alternatively include the surface comprising a surface of a bond coat disposed on a substrate of the gas turbine engine component.

A further embodiment of any of the foregoing embodiments may additionally and/or alternatively include the surface feature comprises a surface feature base width and a surface feature tip width, wherein a ratio of the surface feature base width to the surface feature tip width comprises from 0.0 to 0.22.

A further embodiment of any of the foregoing embodiments may additionally and/or alternatively include the process further comprising forming the surface feature as a pyramid shaped geometric surface feature, the pyramid shaped geometric surface feature comprises an elongated side having the elongated side of a surface feature base width longer than another surface feature base width.

A further embodiment of any of the foregoing embodiments may additionally and/or alternatively include the gas turbine engine component is at least one of an airfoil, a platform, a seal, a bulkhead, a fuel nozzle guide, a transition duct and a combustor liner.

Other details of the coating system are set forth in the following detailed description and the accompanying drawings wherein like reference numerals depict like elements.

### BRIEF DESCRIPTION OF THE DRAWINGS

FIG. 1 is a cross section view of an exemplary gas turbine engine.

FIG. 2 is a turbine section of the turbine engine.

FIG. 3 is an exemplary portion of a turbine article.

FIG. 4 is a schematic representation of geometric surface features of the turbine article.

FIG. 5 is a schematic representation of geometric surface features of the turbine article.

### DETAILED DESCRIPTION

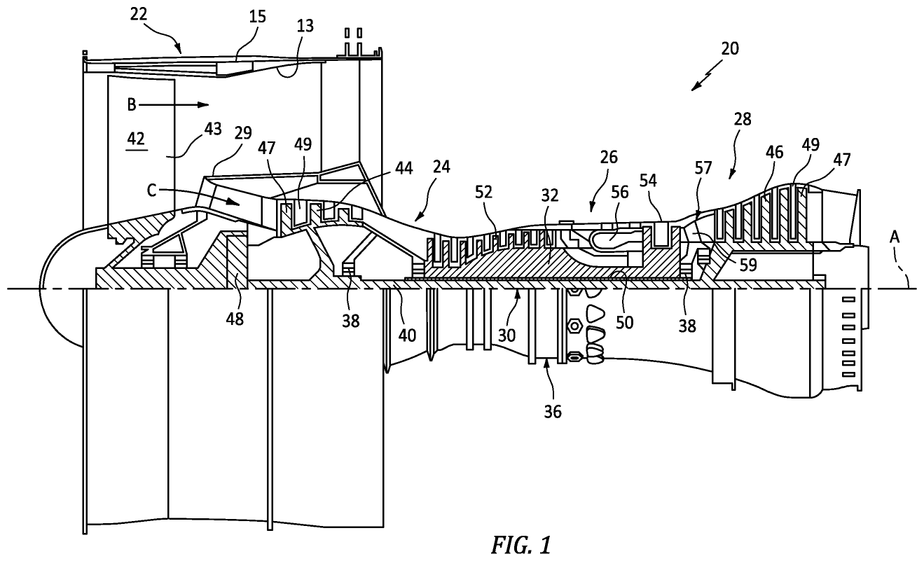

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. The fan section 22 may include a single-stage fan 42 having a plurality of fan blades 43. The fan blades 43 may have a fixed stagger angle or may have a variable pitch to direct incoming airflow from an engine inlet. The fan 42 drives air along a bypass flow path B in a bypass duct 13 defined within a housing 15 such as a fan case or nacelle, and also drives air along a core flow path C for compression and communication into the combustor section 26 then expansion through the turbine section 28. A splitter 29 aft of the fan 42 divides the air between the bypass flow path B and the core flow path C. The housing 15 may surround the fan 42 to establish an outer diameter of the bypass duct 13. The splitter 29 may establish an inner diameter of the bypass duct 13. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects, a first (or low) pressure compressor 44 and a first (or low) pressure turbine 46. The inner shaft 40 is connected to the fan 42 through a speed change mechanism, which in the exemplary gas turbine engine 20 is illustrated as a geared architecture 48 to drive the fan 42 at a lower speed than the low speed spool 30. The inner shaft 40 may interconnect the low pressure compressor 44 and low pressure turbine 46 such that the low pressure compressor 44 and low pressure turbine 46 are rotatable at a common speed and in a common direction. In other embodiments, the low pressure turbine 46 drives both the fan 42 and low pressure compressor 44 through the geared architecture 48 such that the fan 42 and low pressure compressor 44 are rotatable at a common speed. Although this application discloses geared architecture 48, its teaching may benefit direct drive engines having no geared architecture. The high speed spool 32 includes an outer shaft 50 that interconnects a second (or high) pressure compressor 52 and a second (or high) pressure turbine 54. A combustor 56 is arranged in the exemplary gas turbine 20 between the high pressure compressor 52 and the high pressure turbine 54. A mid-turbine frame 57 of the engine static structure 36 may be arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

Airflow in the core flow path C is compressed by the low pressure compressor 44 then the high pressure compressor 52, mixed and burned with fuel in the combustor 56, then expanded through the high pressure turbine 54 and low pressure turbine 46. The mid-turbine frame 57 includes airfoils 59 which are in the core flow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of the low pressure compressor, or aft of the combustor section 26 or even aft of turbine section 28, and fan 42 may be positioned forward or aft of the location of gear system 48.

The low pressure compressor 44, high pressure compressor 52, high pressure turbine 54 and low pressure turbine 46 each include one or more stages having a row of rotatable airfoils. Each stage may include a row of static vanes adjacent the rotatable airfoils. The rotatable airfoils and vanes are schematically indicated at 47 and 49.

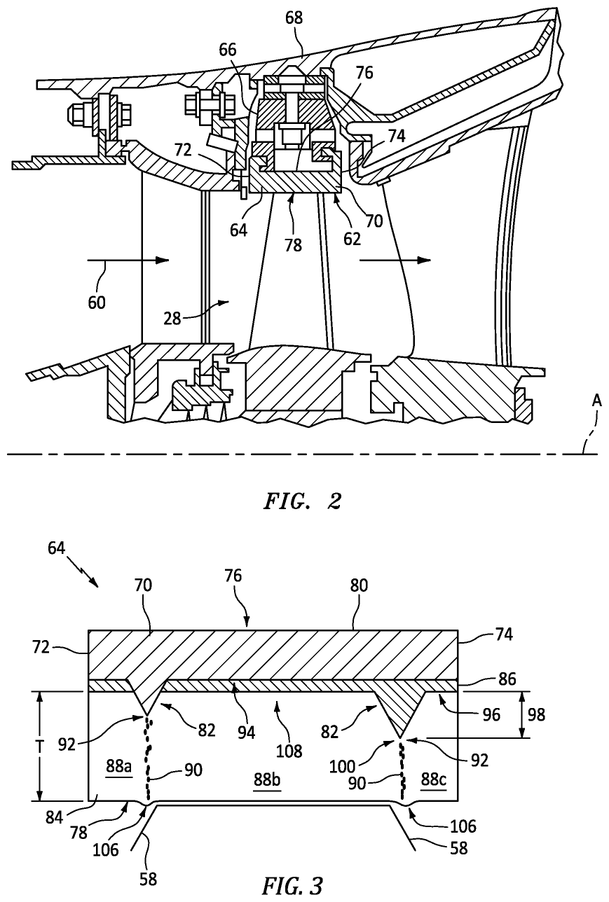

Referring also to FIG. 2 which illustrates selected portions of the turbine section 28. Turbine blades 58 receive a hot gas flow 60 from the combustion section 26 (FIG. 1). The turbine section 28 includes a blade outer air seal system 62, having a plurality of gas turbine articles, such as seal members 64, that function as an outer wall for the hot gas flow 60 through the turbine section 28. Each seal member 64 is secured to a support 66, which is in turn secured to a case 68 that generally surrounds the turbine section 28. For example, a plurality of the seal members 64 may be arranged circumferentially about the turbine section 28. It is to be understood that the seal member 64 is only one example of an article in the gas turbine engine 20 and that there may be other articles within the gas turbine engine 20 that may benefit from the examples disclosed herein.

Referring also to FIG. 3, which illustrates a portion of article/seal member 64 having two circumferential sides 70 (one shown), a leading edge 72, a trailing edge 74, a radially outer side 76, and a radially inner side 78 that is adjacent to the hot gas flow path 60. It should be noted that the view in FIG. 3 is a small section of a part cross section. Leading edge 72 and trailing edge 74 do not necessarily have to be leading and trailing edges of the part, but rather the forward and aft edges of the section shown. In an exemplary embodiment, they can represent actual leading and trailing edges. The term “radially” as used in this disclosure relates to the orientation of a particular side with reference to the engine centerline A of the gas turbine engine 20.

The article/seal member 64 includes a substrate 80, a plurality of geometric surface features 82 (hereafter “surface features”) that can protrude from the substrate 80 on the gas path side of the seal member 64. A thermally insulating topcoat 84 (e.g., a thermal barrier) can be disposed over the plurality of surface features 82. It is to be understood that the surface features 82 may not be shown to scale. The surface feature 82 can also be formed in a bond coat 86. The substrate 80 may include known attachment features for mounting the seal member 64 within the gas turbine engine 20.

The thermally insulating topcoat 84 includes segmented portions 88a-c that are separated by faults 90 extending through the thickness T of the thermally insulating topcoat 84 from the plurality of surface features 82. The faults 90 extend from the tips 92 of the surface features 82. The faults 90 facilitate reducing internal stresses within the thermally insulating topcoat 84 that may occur from sintering of the topcoat material at relatively high surface temperatures within the turbine section 28 during use in the gas turbine engine 20.

Depending on the composition of the topcoat 84, surface temperatures of about 2500° F. (1370° C.) and higher may cause sintering. The sintering may result in partial melting, densification, and diffusional shrinkage of the thermally insulating topcoat 84 and thereby induce internal stresses. The faults 90 provide pre-existing locations for releasing energy associated with the internal stresses (e.g., reducing shear and radial stresses). That is, the energy associated with the internal stresses may be dissipated by the faults 90 such that there is less energy available for causing delamination cracking between the thermally insulating topcoat 84 and the underlying substrate 80 or bond coat 86 and spallation.

The faults 90 may vary depending upon the process used to deposit the thermally insulating topcoat 84, for instance. As an example, the faults 90 may be gaps between neighboring segmented portions 88a-c. Alternatively, or in addition to gaps, the faults 90 may be considered to be microstructural discontinuities between neighboring segmented portions 88a-c. For instance, the individual segmented portions 88a-c may include a microstructure having a plurality of grains of the material that makes up the thermally insulating topcoat 84 and there may be a fault line discontinuity between neighboring segmented portions 88a-c. Thus, the faults 90 may be considered to be planes of weakness in the thermally insulating topcoat 84 such that the segmented portions 88a-c can thermally expand and contract without producing a significant amount of stress from restriction by a neighboring segmented portion 88a-c and/or any cracking that does occur in the thermally insulating topcoat 84 from internal stresses is dissipated through propagation of the crack along the faults 90. Thus, the faults 90 facilitate dissipation of internal stress energy within the thermally insulating topcoat 84.

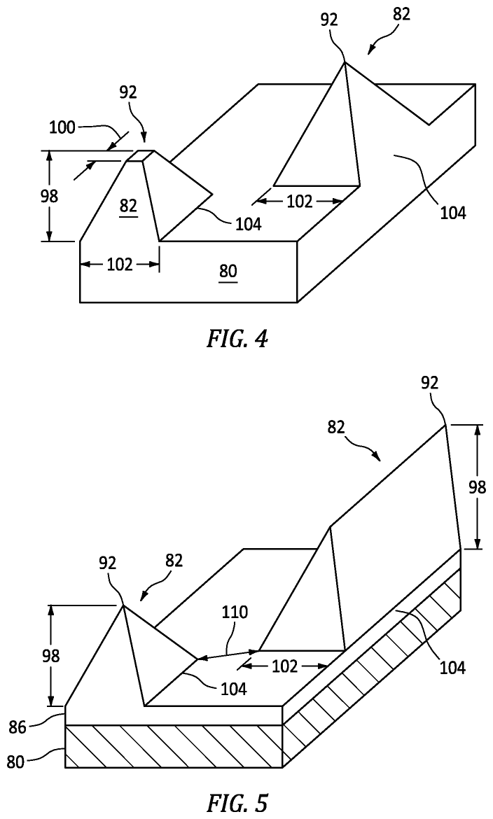

Referring also to FIG. 4 and FIG. 5, the faults 90 may be produced by using any of a variety of different pyramid shaped geometric surface features 82. The pattern of the surface features 82 is not generally limited and may be a grid type of pattern with individual pyramid shaped protrusions that extend from a substrate exterior surface 94 of the substrate 80 and/or extend from a bond coat exterior surface 96 of the bond coat 86.

The dimensions of each of the plurality of geometric surface features 82 may be designed with a particular ratio of a surface feature height 98 of the surface feature 82 to a surface feature tip width 100 of the surface feature 82. There may also be a particular ratio of the surface feature tip width 100 to a surface feature base width 102 of a surface feature base 104. The ratio of the surface feature base width 102 to the surface feature tip width 100 can be as high as from about 0.0 to 0.22.

In some examples, the ratio of the surface feature base width 102 to the surface feature height 98 of the surface features 82 can be 1-10. In further examples, the ratio may be 5 or less, or even 1-3. In some examples, the minimum surface feature height 98 can be 0.01 inches (0.254 millimeters) to facilitate building-up the thermally insulating topcoat 84 on the tips/tops 92 of the surface features 82 in a generally uniform thickness.

For instance, the surface feature base width 102 can be selected such that the bond coat 86 (if used) and thermally insulating topcoat 84 can be built-up onto the top or tip 92 of the surface feature 82 during the deposition process. As seen in FIG. 5, the pyramid shaped geometric surface features 82 can be elongated along a predetermined side such that one side of the base 104 can be longer than another base width 102. The resulting shape of the surface feature 82 can be an elongated rib shape.

Likewise, as seen in FIG. 3, the height 98 of surface feature 82 can be selected such that a hump portion 106 of the thermally insulating topcoat 84 that builds-up on the tip/top 92 of the surface feature 82 is discontinuous from other portions of the thermally insulating topcoat 84 that build-up in the valleys/lower recess portion 108, between the surface features 82. The hump portion 106 discontinuity on the surface of the thermally insulating topcoat 84 proximate the radially inner side 78 can be used to provide clearance control in a shroud/blade outer air seal section. In another exemplary embodiment, the hump portion 106 can be employed to abrade away in the case of a rub event with the turbine blade 58. In another exemplary embodiment, the hump portion 106 can be machined to create a smooth surface finish for incorporation into components such as combustors, blade and vanes.

A spacing 110 between the geometric surface features 82 may also be selected to facilitate reducing internal stresses of the thermally insulating topcoat 84. As an example, the spacing 110 between the surface features 82 may be selected with regard to the thickness T of the thermally insulating topcoat 84, such as the thickness taken from the top of the surface features 82 or bond coat 86 to the radially inner side 78, as indicated by arrow T.

In some examples, a ratio of the spacing 110 between the surface features 82 to the thickness T of a thermally insulating topcoat 84 may be 5 or less. The selected spacing 110 may be smaller than a spacing of cracks that would occur naturally, without the faults 90, which makes the thermally insulating topcoat 84 more resistant to spalling and delamination. Thus, different spacing 110 is appropriate for different thicknesses T of the thermally insulating topcoat 84.

In an exemplary embodiment, the thermally insulating topcoat 84 can have very high coating thickness T, of greater than 0.020 inches.

The material selected for the substrate 80, bond coat 86 (if used), and thermally insulating topcoat 84 are not necessarily limited to any particular kind. For the seal member 64, the substrate 80 may be a metal alloy, such as a nickel based alloy. The bond coat 86 may include any suitable type of bonding material for attaching the thermally insulating topcoat 84 to the substrate 80. In some embodiments, the bond coat 86 includes a nickel alloy, platinum, gold, silver, or MCrAlY where the M includes at least one of nickel, cobalt, iron, or combination thereof, Cr is chromium, Al is aluminum and Y is yttrium. The bond coat 86 may be approximately 0.005 inches thick (approximately 0.127 millimeters), but may be thicker or thinner depending, for example, on the type of material selected and requirements of a particular application.

The thermally insulating topcoat 84 may be any type of ceramic material suited for providing a desired heat resistance in the gas turbine article. As an example, the thermally insulating topcoat 84 may be an abradable coating, such as yttria stabilized with zirconia, hafnia, and/or gadolinia, gadolinia zirconate, molybdate, alumina, or combinations thereof. The topcoats 84 may also include porosity. While various porosities may be selected, typical porosities in a seal application include 5 to 70% by volume. Given this description, one of ordinary skill in the art will recognize other types of ceramic or even metallic materials that could be used for the thermally insulating topcoat 84.

The faults 90 may be formed during fabrication of the thermally insulating topcoat 84. As an example, a thermal spray process may be used to deposit the thermally insulating topcoat 84 onto the substrate 80 and bond coat 86, if used. The bond coat 86 may be deposited using known deposition methods onto portions of the surface features 82 prior to deposition of the thermally insulating topcoat 84. In this case, the deposition process may be a line-of-sight process such that the sides of the surface features include less bond coat 86 material or are free of any bond coat 86 material. That is, the bond coat 86 may be discontinuous over the surface of the substrate 80. The bond coat 86 may also be deposited in a thickness that is less than the height 98 of the surface features 82 to facilitate avoiding bridging of the bond coat 86 over the surface features 82.

In a further example, the process parameters and equipment used in the thermal spray process that may be selected to form the faults 90. For instance, the thermal spray process may utilize a tungsten-lined plasma torch having internal features for facilitating consistent arc root attachment and improved plasma temperature consistency, velocity, particle temperature, and particle trajectory. The nozzle exit diameter may be approximately 0.3125 inches (approximately 8 millimeters), for instance.

Additionally, the plasma spray process may be controlled to project molten droplets of the thermally insulating topcoat 84 material at an angle of 90°+/−5° relative to the top surfaces of the surface features 82 in order to deposit the thermally insulating topcoat 84 with sharp corners that have minimal rounding and without bridging between the portion of the thermally insulating topcoat 84 that builds-up in the valleys between the surface features 82 and the portion on top of the surface features 82. For instance, relative motion between the torch nozzle and the seal member 64 or other type of part may be controlled to maintain the 90°+/−5° angle.

Powder injection into the torch nozzle may also be controlled to achieve a spray plume having a narrow divergence from the 90°+/−5° angle. For instance, the nozzle may include larger powder ports than used in conventional plasma spray processes and a relatively low carrier gas flow rate may be used. The resulting powder injection has increased width across the plasma but a narrow divergence from the 90°+/−5° due to particle size segregation in the direction of injection.

The plasma parameters may also be controlled to achieve desirable particle heating and deposition dynamics and form a strongly bonded thermally insulating topcoat 84. For instance, the plasma parameters may include using 99 standard cubic feet per hour (scfh) of nitrogen, 21 scfh hydrogen, 36 kilowatts at the torch, 12 scfh of carrier gas per port (e.g., nitrogen or argon), two #4 Sulzer Metco powder ports set at 90° relative to each other, and 30 grams per minute of powder per port.

The surface feature 82 forming process is selected to produce the sharp tips 92. Sharp tips 92 at the top of the surface features 82 are necessary for producing the necessary coating segmentation structure 88a-c. In another exemplary embodiment, the process can form sharp tips 92 to any degree or combination as necessary to produce the coating segmentation structure 88a-c.

The geometric surface features 82 may be selected to be any of a variety of different patterns.

A technical advantage of the disclosed coating system includes a reduction in the amount of cooling air required to operate high pressure turbine hardware.

Another technical advantage of the disclosed coating system includes improving the durability of air plasma sprayed thermal barrier coating.

Another technical advantage of the disclosed coating system includes permitting operation at higher temperature or with lower cooling air flow rate.

There has been provided a coating system. While the coating system has been described in the context of specific embodiments thereof, other unforeseen alternatives, modifications, and variations may become apparent to those skilled in the art having read the foregoing description. Accordingly, it is intended to embrace those alternatives, modifications, and variations which fall within the broad scope of the appended claims.

What is claimed is:

1. A process of preventing spallation for a geometrically segmented thermally insulating top coat on an article, the process comprising:
forming a surface feature with a surface feature tip on a surface of the article;
disposing the thermally insulating topcoat over the surface feature; and
forming segmented portions that are separated by faults extending through the thermally insulating topcoat from the surface feature tip.

2. The process according to claim 1, wherein the surface feature comprises a pyramid shape.

3. The process according to claim 1, wherein the surface comprises a surface of a substrate of the article.

4. The process according to claim 1, wherein the surface comprises a surface of a bond coat disposed on a substrate of the article.

5. The process according to claim 1, wherein the surface feature comprises a pyramid shape including a surface feature base width and a surface feature tip width, wherein a ratio of the surface feature base width to the surface feature tip width comprises from 0.0 to 0.22.

6. The process according to claim 1, wherein the article is a gas turbine engine component.

7. The process according to claim 6, wherein the gas turbine engine component is at least one of an airfoil, a platform, a seal, a bulkhead, a fuel nozzle guide, a transition duct and a combustor liner.

8. A geometrically segmented thermally insulating top coat on an article comprising:
a surface feature shaped as a pyramid with a surface feature tip, the surface feature formed on a surface of the article;
the thermally insulating topcoat being disposed over the surface feature; and
segmented portions that are separated by faults extending through the thermally insulating topcoat from the surface feature tip.

9. The geometrically segmented thermally insulating top coat on an article according to claim 8, wherein the surface comprises a surface of a substrate of the article.

10. The geometrically segmented thermally insulating top coat on an article according to claim 8, wherein the surface comprises a surface of a bond coat disposed on a substrate of the article.

11. The geometrically segmented thermally insulating top coat on an article according to claim 8, wherein the surface feature comprises a surface feature base width and a surface feature tip width, wherein a ratio of the surface feature base width to the surface feature tip width comprises from 0.0 to 0.22.

12. The geometrically segmented thermally insulating top coat on an article according to claim 11, wherein the pyramid shaped geometric surface feature comprises an elongated side having the elongated side of a surface feature base width longer than another surface feature base width.

13. The geometrically segmented thermally insulating top coat on an article according to claim 12, wherein the resulting shape of the surface feature comprises an elongated rib shape.

14. A process of interrupting spallation for geometrically segmented coatings on a gas turbine engine component comprising:
the gas turbine engine component having a surface;
forming a surface feature with a surface feature tip on the surface of the gas turbine engine component;
disposing the thermally insulating topcoat over the surface feature; and
forming segmented portions that are separated by faults extending through the thermally insulating topcoat from the surface feature tip.

15. The process according to claim 14, wherein the surface feature comprises a pyramid shape.

16. The process of claim 14, wherein the surface comprises a surface of a substrate of the gas turbine engine component.

17. The process of claim 14, wherein the surface comprises a surface of a bond coat disposed on a substrate of the gas turbine engine component.

18. The process of claim 14, wherein the surface feature comprises a surface feature base width and a surface feature tip width, wherein a ratio of the surface feature base width to the surface feature tip width comprises from 0.0 to 0.22.

19. The process of claim 14, further comprising:
forming the surface feature as a pyramid shaped geometric surface feature, the pyramid shaped geometric surface feature comprises an elongated side having the elongated side of a surface feature base width longer than another surface feature base width.

20. The process of claim 14, wherein the gas turbine engine component is at least one of an airfoil, a platform, a seal, a bulkhead, a fuel nozzle guide, a transition duct and a combustor liner.
